(19) United States
(12) Patent Application Publication
(10) Pub. No.: US 2011/0272318 A1
(43) Pub. Date: Nov. 10, 2011

(54) TIGHTLY NESTABLE PLASTIC CUPS AND CONTAINERS WITH IMPROVED RIGIDITY-TO-WEIGHT CHARACTERISTICS

(75) Inventors: William A. Gallop, Westminster, MA (US); Ashish K. Mithal, Chelmsford, MA (US)

(73) Assignee: WADDINGTON NORTH AMERICA, INC., Chelmsford, MA (US)

(21) Appl. No.: 13/102,569

(22) Filed: May 6, 2011

Related U.S. Application Data
(60) Provisional application No. 61/331,857, filed on May 6, 2010.

(51) Int. Cl. B65D 21/00; B29C 45/00; B29C 51/00; B65D 1/00; B65D 51/00

(52) U.S. Cl. 206/518; 220/660; 220/200; 264/299; 264/320; 264/328.1

(57) ABSTRACT

A cup or container offers improved rigidity-to-weight ratio and tight nesting. The cup or container has four flat or moderately concave sidewalls arranged to form a substantially square cross section. An upper rim is moderately convex or round and/or otherwise shaped and/or reinforced to resist distortion. The stiff upper rim causes the cup or container to resist deformation by compression of sidewalls during handling and use, because the walls cannot be deformed without deforming the rim, thereby providing a more functional and usable cup or container at a reduced weight compared to prior art cups having different shapes and/or convex sidewalls. The cup or container can be thermoformed or injection molded. Sidewalls can be less than 0.33, 0.3, 0.28 or 0.25 mm thick with volumes of less than 6, 5, 4, or 3 oz respectively. A lid can be included for attachment to the upper rim.

### RELATED APPLICATIONS

This application claims the benefit of U.S. Provisional Application No. 61/331,857, filed May 6, 2010, which is herein incorporated by reference in its entirety for all purposes.

### FIELD OF THE INVENTION

The invention relates to cups and containers, and more particularly to stackable cups and containers having generally thin and flexible walls.

### BACKGROUND OF THE INVENTION

Due to ever increasing environmental and economic pressures, there is a growing need to produce cups, containers and similar food service items which are progressively lighter in weight and can be stacked together in a relatively tight, nested configuration for efficient storage and transportation. In addition to cost savings, having a low weight and tightly nested cup or container configuration allows a food-service establishment to achieve a lower carbon footprint and certain storage and freight efficiencies.

One approach of making a lighter weight cup is to simply reduce the wall thickness of an existing style of cup or container, without changing its shape or its material of manufacture. However, as will be appreciated by those of ordinary skill in the art, reducing the wall thickness of a cup or container will necessarily weaken its structure, and may render the cup or container unsuitable for its intended purpose, difficult to handle, or both. For example, grasping a very thin walled cup containing a beverage may cause the sidewalls to be inwardly displaced and the beverage to be inadvertently spilled.

Typically, it may not be practical to compensate for thinner walls by using a stiffer plastic or similar material and employing a stiffer material may fail to provide the desired benefit, either in terms of performance, costs, or both. For instance, employing a material that is twice as stiff leads to a 2-fold increase in bending stiffness of a flat beam. However, doubling the thickness of the same flat beam results in an 8-fold increase in bending stiffness. Thus, wall thickness reductions have a significantly greater contribution in terms of stiffness reductions.

A mechanical feature that is often used to strengthen various types of beam structures is a convex arcuate construction which allows for better load bearing and resistance to bending and deflection. In these scenarios, a beam or similar structure is fabricated with a curvature bias and pre-bent in a direction opposite to the direction of deflection. This principle is often employed in bridges, home construction, tractor trailer beds, and such like. Reasoning by analogy from these examples suggests that an outwardly arcuate construction (convex curvature) of the sidewalls of a thin-walled plastic container would improve its resistance to compressive stress on its sidewalls.

However, experiments with cups and containers ranging from 1 oz. to 5 oz. and having a square cross-section have shown that this analogous reasoning is incorrect insofar as thin flexible cups are concerned, and fails to provide the expected benefit. The problem is particularly acute when the cups are constructed from a relatively flexible plastic material such as polypropylene. In fact it was found that convex shaping of the sidewalls fails to provide a satisfactory cup at the targeted weight level due to the sidewalls exhibiting significant deflection when held or handled during customary use. Sidewall deflection was particularly noticeable on square shaped cups with outwardly projecting (convexly curved) sidewalls having wall thicknesses of less than about 0.012″ or 0.3 mm. For these cups, the cup walls appeared to collapse even while handling the cups gently and the cups were practically unusable.

Sidewall deflection is important from the standpoint of having a usable cup as well as from the standpoint of user perception, as excessive flexing of the sidewalls is deemed unacceptable even though the cup may be usable from other perspectives, such as the cup's ability to resist collapse when subjected to a top load. After noticing the less-than-desirable performance of convexly curved sidewalls on square containers, the inventors considered various other options, including increasing the thickness of the sidewalls and trying other sidewall geometries. During this development effort, the inventors experimented with moderately concave walls, and unexpectedly noticed that square containers having moderately concave walls offered a greater resistance to sidewall deformation compared to outwardly projecting (convexly curved) walls.

In order to obtain a tight, practical nesting, it is desirable that the cups be stacked as tightly as possible, with minimal spacing between the sidewalls of consecutive cups in the stack, while also allowing quick separation of the cups, so that the cups can be readily withdrawn from the stack in a singulative manner or one-at-a-time without sticking and used in a high volume food-service operation or establishment. In container geometries where the mouth of a cup or container was wider than the walls (see for example FIG. 2C), it was expected that convexly shaped sidewalls would perform better than moderately concave sidewalls since these convex-walled constructions afforded the opportunity of reducing interference between two consecutive cups or containers in a stacked configuration. Contrary to this expectation, however, it was found that convex shaping of the sidewalls caused the sidewalls to deform more easily when they were grasped as compared to concave side walls, thereby adversely affecting the nestability of the cups or containers by making it more difficult to separate them when nested. On the other hand, cups and containers having moderately concave sidewalls offered improved nestability and opportunity for better storage and shipping efficiencies because the side walls did not deform as easily when they were grasped, thereby making the nested cups or containers easier to separate.

When a cup stack comprising a plurality of convex sidewall cups arranged in a mouth-down configuration was tested, it was noticed that the sidewalls of the exposed or top cup had a significant propensity to deform during lifting and handling of the top cup, which in turn caused the walls of the selected top cup to press against or depress one or more adjacent cups in the cup stack, and thereby tended to cause two or more cups to stick together when a user tried to retrieve a single cup from the cup stack. In a relatively busy food service operation, this would be particularly cumbersome and time consuming for the meal preparer and could lead to added expense for the restaurant.

The deformation of thin sidewalls, especially thin convex sidewalls, can also be particularly troublesome during installation of a lid on a cup or container, because excessive deformation of the sidewalls due to pressing of the lid onto the rim of the cup or container can cause the cup or container to deform or buckle. In addition, sidewall deformation poses a particular problem during lid removal. Customarily, when a user removes a lid from a cup or container, they naturally grasp the sidewalls very firmly. In the case of a thin-walled cup, especially a cup with convex sidewalls, this can cause the sidewalls to be substantially deformed during lid removal, which can lead to spillage of the contents due to inward compression of two opposing sidewalls and the displacement of contents and/or consequent reduction of the interior volume of the cup.

Therefore, there is a need for a new construction for cups and containers which will improve the rigidity-to-weight ratio for a given material of construction and provide other advantages discussed above. Additional features and benefits shall further become apparent from the detailed description of the invention.

### SUMMARY OF THE INVENTION

The present invention discloses cups and containers which offer an improved rigidity-to-weight ratio due to the geometry of their construction. The cup or container is configured with a substantially square cross section and an upper rim that resists deformation, both along the sides and at the corners. The sidewalls of the cup or container are substantially flat or moderately concave, which the inventors found are unlikely to be deformed without causing a corresponding deformation of the upper rim of the cup or container, including a deformation of the corners of the upper rim. The stiff upper rim thereby provides enhanced resistance of the sidewalls to deformation.

In addition, as the sidewalls exhibit a reduced tendency to deform, retrieving a cup from the stack does not interfere with other cups in the stack.

One general aspect of the present invention is a container with enhanced resistance to sidewall compression. The container includes a base defining a bottom closed end of said container and having four peripheral edges, said base being approximately square in shape. The container further includes four sidewalls, each sidewall comprising a top edge, a bottom edge and a pair of side edges, said four sidewalls rising upwardly from said base with the bottom edges of the four sidewalls being respectively joined to said four peripheral edges of said base, said four sidewalls being joined to each other at their side edges and defining an interior closed space for containing a substance therein, the top edges of the four sidewalls being joined together to form a top inner periphery and defining a top open end of said container, said top inner periphery being approximately square in shape, the four sidewalls being one of flat and bowed inward toward said interior closed space of the container. The container further includes an upper rim circumscribing said top inner periphery and attached thereto at said top open end of said container, said upper rim having a top outer periphery, said upper rim being adapted to resist deformation thereof.

In embodiments, the four sidewalls have heights which are not greater than their widths. Some embodiments further include a lid which is configured for attachment to the upper rim. In other embodiments the container has an interior volume of approximately 2 fluid ounces.

In various embodiments, said container is adapted for tight nesting in a stack of a plurality of similar containers, said container being removable from said stack of said plurality of similar containers in a singulative manner.

In certain embodiments, the four sidewalls are bowed inward toward said interior closed space of said container. In some embodiments, at least portions of said top outer periphery of the upper rim are bowed outward away from said interior closed space of said container. And in other embodiments said top outer periphery of the upper rim is round.

In various embodiments said top outer periphery of said upper rim includes a downwardly projecting skirt. In certain embodiments at least a portion of the container is made from a polypropylene material. And in other embodiments at least a portion of the container is made from one of polystyrene, high impact polystyrene, and styrene-butadiene copolymer.

In some embodiments the sidewalls are less than 0.33 mm in thickness, and the container has a fluid capacity of less than about 6 oz. In other embodiments the cup sidewalls are less than 0.3 mm in thickness, and the cup or container has a fluid capacity of less than about 5 oz. In still other embodiments the sidewalls are less than 0.28 mm in thickness, and the container has a fluid capacity of less than about 4 oz. And in yet other embodiments the sidewalls are less than 0.25 mm in thickness, and the container has a fluid capacity of less than about 3 oz.

In various embodiments said container is injection molded. And in certain embodiments said container is a component of a cup and lid assembly for carrying food from one location to another, said food including one of dressings, condiments, sauces, butter, spread, and oil.

Another general aspect of the present invention is a method for manufacturing a cup or container with enhanced resistance to sidewall compression. The method includes molding a plastic material to form a cup or container, the cup or container having base defining a bottom closed end of said container and having four peripheral edges, said base being approximately square in shape, four sidewalls, each sidewall comprising a top edge, a bottom edge and a pair of side edges, said four sidewalls rising upwardly from said base with the bottom edges of the four sidewalls being respectively joined to said four peripheral edges of said base, said four sidewalls being joined to each other by their side edges for defining an interior closed space for containing a substance therein and arranged to have a cross section which is approximately square in shape, the top edges of the four sidewalls being joined together to form a top inner periphery and defining a top open end of said container, said top inner periphery being approximately square in shape, the four sidewalls being one of flat and bowed inward toward said interior closed space of the container, and an upper rim circumscribing said top inner periphery and attached thereto at said top open end of said container, said upper rim having a top outer periphery, said upper rim being adapted to resist deformation thereof.

In various embodiments the cup or container is formed from a single, contiguous portion of plastic. In some embodiments the cup or container is formed from a single contiguous sheet of plastic. In other embodiments the cup or container is formed by thermoforming a contiguous sheet of plastic.

In certain embodiments the cup or container is formed by injection molding of the plastic. In other embodiments at least a portion of the cup or container is made from a polypropylene material. And in yet other embodiments at least a portion of the cup or container is made from one of polystyrene, high impact polystyrene, and styrene-butadiene copolymer.

In various embodiments the sidewalls are less than 0.25 mm in thickness. In certain embodiments the container has a fluid capacity of greater than 1 oz.

In some embodiments said cup or container is adapted for tight nesting in a stack of a plurality of similar cups or containers, said cup or container being removable from said stack of said plurality of similar cups or containers in a singulative manner.

In other embodiments the four sidewalls are bowed inward toward said interior closed space of said cup or container.

In certain embodiments at least portions of said top outer periphery of the upper rim are bowed outward away from said interior closed space of said cup or container. In some embodiments said top outer periphery of the upper rim is round.

In various embodiments said top outer periphery of said upper rim includes a downwardly projecting skirt. And in some embodiments said cup or container is a component of a cup and lid assembly for carrying food from one location to another, said food including one of dressings, condiments, sauces, butter, spread, and oil.

Another general aspect of the present invention is a container having enhanced resistance to sidewall compression. The container includes a base defining a bottom closed end of said container and having four peripheral edges, said base being approximately square in shape. The container further includes four sidewalls, each sidewall comprising a top edge, a bottom edge and a pair of side edges, said four sidewalls rising upwardly from said base with the bottom edges of the four sidewalls being respectively joined to said four peripheral edges of said base, said four sidewalls being joined to each other at their side edges and defining an interior closed space for containing a substance therein, the top edges of the four sidewalls being joined together to form a top inner periphery and defining a top open end of said container, the inner periphery being approximately square in shape and said top edges of the four sidewalls being curved inwardly toward said interior closed space of the container. The container also includes an upper rim circumscribing said top inner periphery and attached thereto at said top open end of said container, said upper rim having a top outer periphery, said upper rim being adapted to resist deformation thereof.

In embodiments at least a portion of the container is made from a polypropylene material. In certain embodiments at least a portion of the container is made from one of polystyrene, high impact polystyrene, and styrene-butadiene copolymer.

In some embodiments the sidewalls are less than 0.25 mm in thickness. In other embodiments the container has a fluid capacity of greater than 1 oz.

Various embodiments further include a lid which is configured for attachment to the upper rim. In certain embodiments said container is adapted for tight nesting in a stack of a plurality of similar cups or containers, said container being removable from said stack of said plurality of similar cups or containers in a singulative manner.

In some embodiments the four sidewalls are bowed inward toward said interior closed space of said container. In other embodiments at least portions of said top outer periphery of the upper rim are bowed outward away from said interior closed space of said container. In still other embodiments said top outer periphery of the upper rim is round. And in yet other embodiments said top outer periphery of said upper rim includes a downwardly projecting skirt.

In various embodiments said container is a component of a cup and lid assembly for carrying food from one location to another, said food including one of dressings, condiments, sauces, butter, spread, and oil. And in some embodiments said sidewalls have a thickness of between 0.2 mm to 0.25 mm.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view from above of a cup embodiment of the present invention which has concave sidewalls;

FIG. 1B is a shaded view from above of the embodiment of FIG. 1A;

FIG. 1C is a perspective view from the side of the embodiment of FIG. 1A;

FIG. 1D is a side view of an embodiment similar to the embodiment of FIG. 1A in which the upper rim includes a downwardly projecting skirt;

FIG. 1E is an enlarged sectional view of a section through the upper rim of FIG. 1D;

FIG. 1F is a side view of an embodiment similar to FIG. 7A but including a compatible lid;

FIG. 1G is an enlarged sectional view of a section through the upper rim of FIG. 7C;

FIG. 2A is a perspective view from above of a cup with convex sidewalls, which is not an embodiment of the present invention;

FIG. 2B is a shaded view from above of the cup of FIG. 2A;

FIG. 2C is a perspective view from the side of the embodiment of FIG. 2A;

FIG. 3A is a perspective view from above of an embodiment of the present invention which has flat sidewalls;

FIG. 3B is a shaded view from above of the embodiment of FIG. 3A;

FIG. 3C is a perspective view from the side of the embodiment of FIG. 3A;

FIG. 4 is a perspective view of the embodiment of FIG. 1A

FIG. 5A is a side view of the embodiment of FIG. 1A, illustrating opposing lateral forces applied to opposing sidewalls;

FIG. 5B is a top view of the upper rim of the embodiment of FIG. 1A, illustrating forces applied to the upper rim due to the lateral forces of FIG. 5A;

FIG. 6A is a perspective line drawing of the embodiment of an embodiment which includes concave walls and an upper rim with a round outer edge;

FIG. 6B is a side view line drawing of FIG. 6A;

FIG. 6C is a top view line drawing of the embodiment of FIG. 6A;

FIG. 6D is a perspective solid illustration of the embodiment of FIG. 6A; and

FIG. 6E is a top solid illustration of the embodiment of FIG. 6A.

### DETAILED DESCRIPTION

The present invention introduces cups and containers which offer improved performance due to the geometry of their construction. According to various embodiments of the invention, the cups and containers inter alia provide some or all of the following features: improved rigidity-to-weight ratio; improved sidewall strength; reduced deformation while handling or lifting; reduced tendency for spillage of contents while removing the lid from the container; reduced deformation during removal from a nested stack of a plurality of cups and containers; reduced stacking height; and ability to provide a tightly nested configuration. These features may confer one or more of the following commercial and practical advantages: increased storage and freight efficiency; lower part weight; reduced material cost; and a lower carbon footprint.

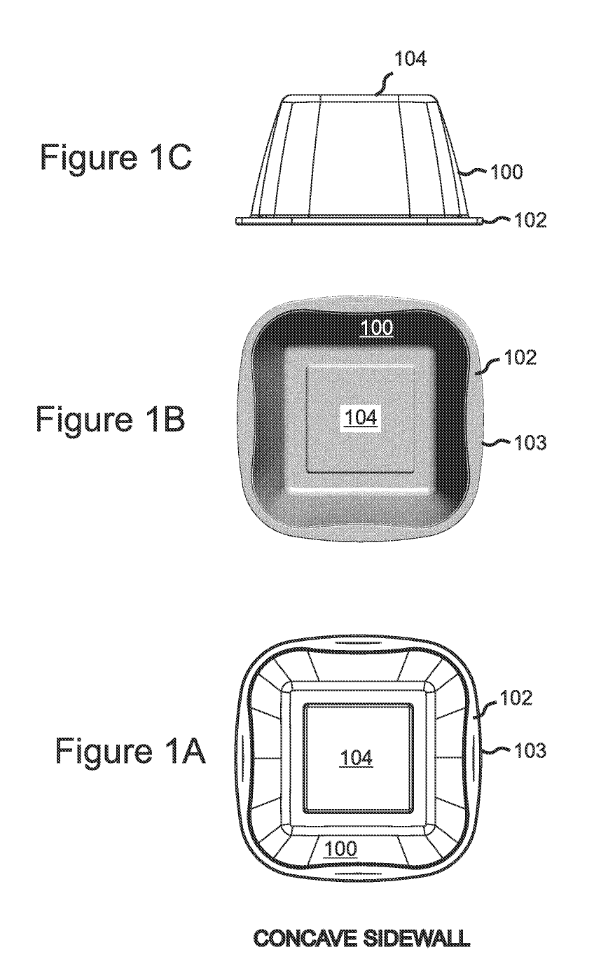

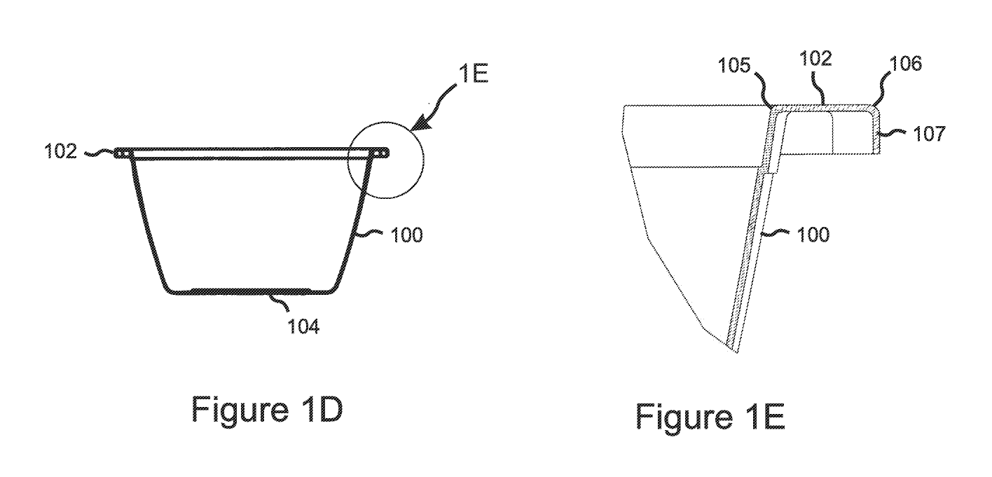

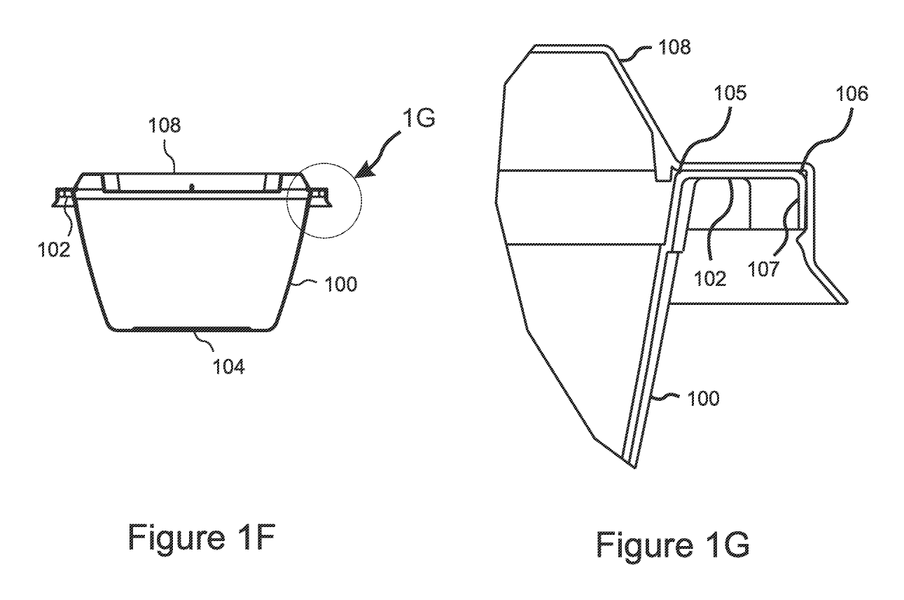

With reference to FIGS. 1A through 1C, the cup or container according to an embodiment of the present invention is configured with sidewalls 100 arranged so as to have a substantially square cross section and an upper periphery surrounded by an upper rim 102. The square cross-sectional shape can be seen in the shaping of the bottom 104 of the cup.

The side walls 100 of the cup or container in the embodiment of FIGS. 1A through 1C are moderately concave, which ensures that they are less likely to be deformed inward without a corresponding deformation of the upper rim 102 of the cup or container, including a deformation of the corners of the upper rim. As shown, the upper rim 102 includes a flat flange portion 103 which is wider towards the top center and serves to act as a stiffening feature, allowing the sidewalls 100 to resist deformation.

FIG. 1D is a side view of an embodiment similar to FIG. 1A, and FIG. 1E is a perspective sectional view through the upper rim 102 of FIG. 1D, showing the top inner periphery 105, top outer periphery 106, and a downwardly depending lip or skirt 107. In addition, upper rim 102 may include connecting ribs or similar features for further enhancing the stiffness of the upper rim 102.

FIG. 1F is a side view of the cup of FIG. 1D shown engaged with a cooperating lid 108 to allow a food service establishment or restaurant to serve its take-out customers and to allow transportation of food from the restaurant to a user's home or workplace. FIG. 1G is a perspective sectional view through the upper rim 102 of FIG. 1E.

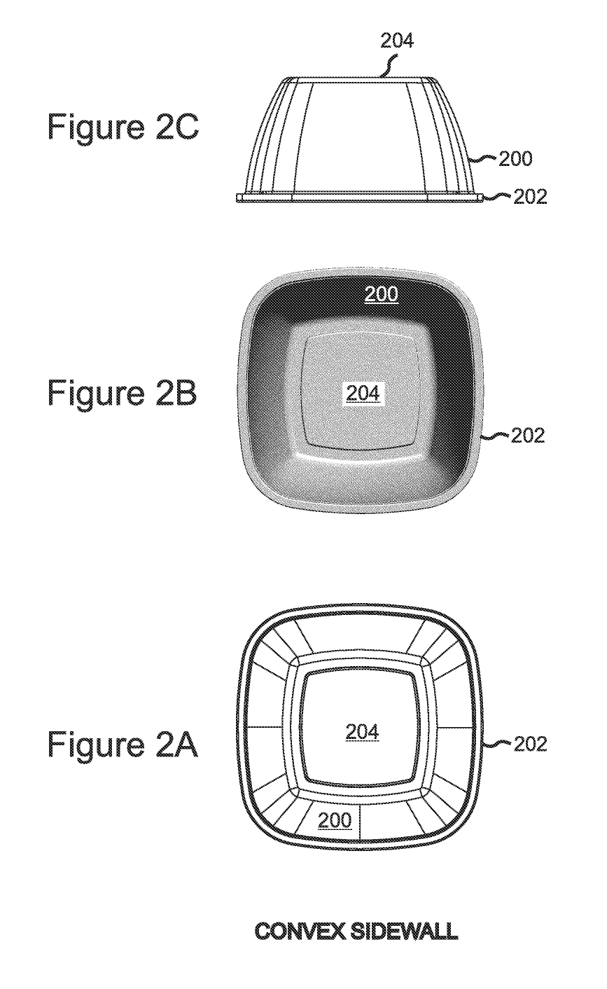

FIGS. 2A through 2C are views of a cup having convex side walls 200 which is similar to the embodiment of FIGS. 1A through 1C in some aspects, but is not an embodiment of the present invention. Contrary to the general practice of providing convex arcuate geometries similar to those used for a structural arch or beam in a building or bridge, the convexity of the sides 200 of the cup of FIGS. 2A through 2C does not offer the expected benefit. The convex shape of the sidewalls merely provides a mechanism for the sides 200 to be deformed inwardly without significantly distorting the upper rim 202 of the cup. The cup of FIGS. 2A through 2C therefore provides less resistance to compression of its side walls than the embodiment of FIGS. 1A through 1C. In other words, the cup construction with convex sidewalls shown in FIGS. 2A through 2C has a tendency to deform readily when compressed.

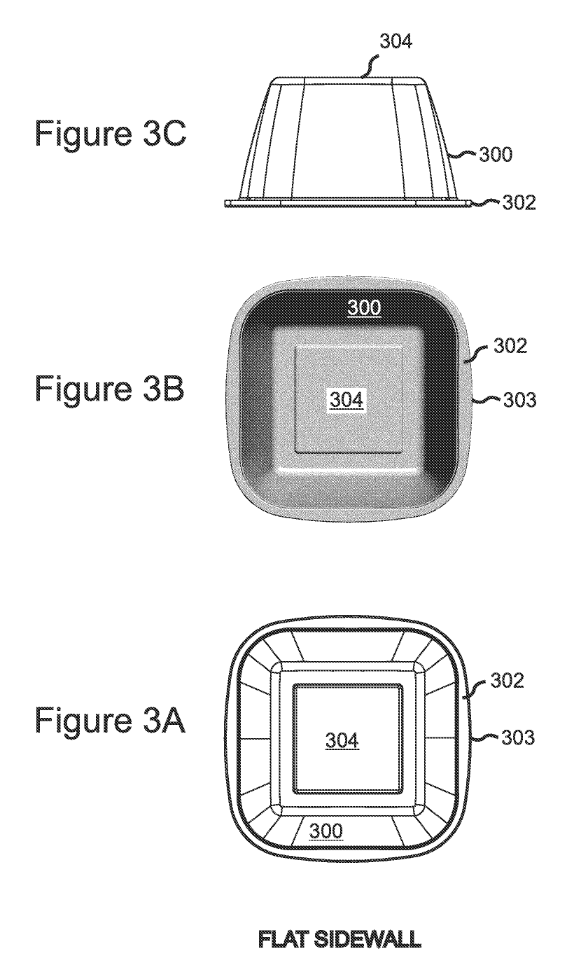

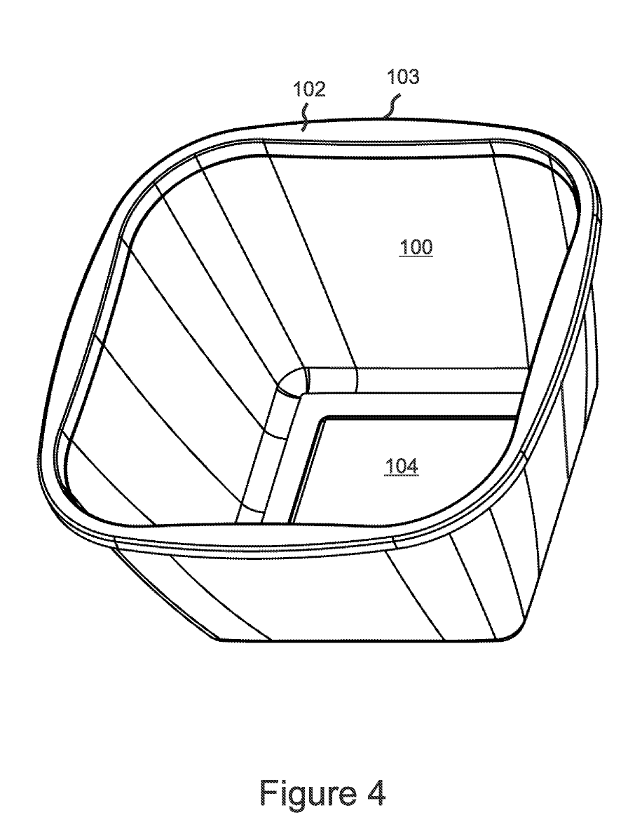

FIGS. 3A through 3C depict an embodiment of the present invention which has flat walls. As with the embodiment of FIGS. 1A through 1C, the side walls 300 of the cup of this embodiment cannot be pressed inward without flexing and distorting the stiff upper rim 302 of the cup. In other words, the geometries of FIGS. 1A through 1C and 3A through 3C provide enhanced sidewall stiffness as compared to the geometry of FIGS. 2A through 2C, even when all three configurations have the same wall thickness and are made from the same material. It is noteworthy, however, that during injection molding a flat sidewall may acquire an unpredictable or unintended curvature due to varying processing conditions, mold temperature variations, molded-in stresses, rate of cooling, presence of ejection air, draft angle of the cup etc. Therefore, moderately concave sidewalls as shown in FIGS. 1A through 1C are preferred over the straight sidewalls of FIGS. 3A through 3C. A molded-in concave curvature of the sidewalls ensures that the sidewalls maintain a concave bias after molding and do not acquire an undesirable convex bias due to post-molding shrinkage or other processing-related factors.

FIG. 4 is a perspective view from an oblique angle of the embodiment of FIGS. 1A through 1C.

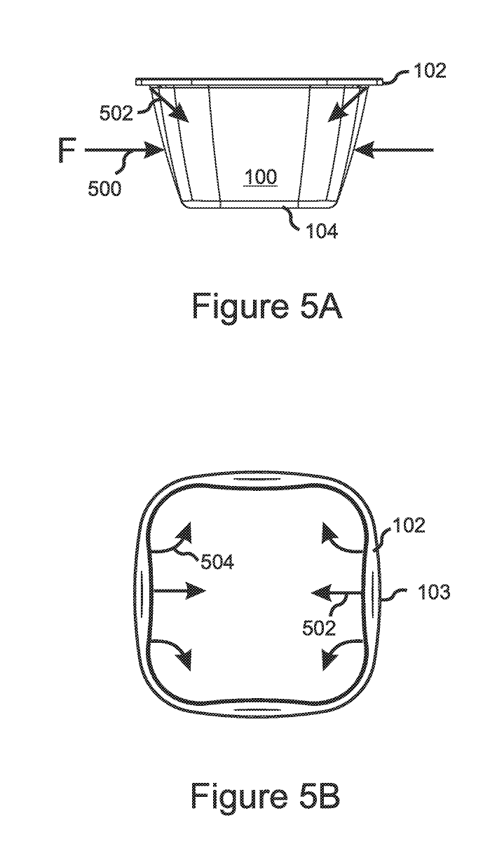

FIGS. 5A and 5B illustrate generally the interaction between forces 500 applied to the side walls 100 of the embodiment of FIGS. 1A through 1C, and consequent forces 502, 504 applied to the upper rim 102. As can be seen in FIG. 5A, application of opposing lateral forces 500 to opposing side walls 100 of the cup, as might be applied for example by the thumb and opposing fingers of a user's hand while holding the cup, causes the side walls to tend to deform inward. But this immediately applies a consequent downward and inward force 502 to the edges of the upper rim 102 which are directly above the compressed side walls 100. FIG. 5B illustrates the components of these consequent forces which lie in the horizontal plane. As can be seen in the figure, bending forces 504 are also applied at the corners of the cup.

Since the upper rim 102 of the cup is highly resistant to bending and flexing, the result is enhanced resistance to compressive forces 500 applied to the side walls 100.

As shown in FIGS. 1F and 1G, the cups and containers according to the present invention can be fitted with a cooperating lid. One particular advantage of using a cup construction which is less susceptible to deformation during use is that it provides ease of use with a cooperating lid. As will be appreciated, the cup sidewalls are held and depressed by a user when removing a lid from a cup or container, and any unusual deformation of the sidewalls can result in spilling of the contents.

The cups and containers according to the present invention can be constructed from a variety of materials by utilizing a plurality of processing techniques known in the art. In one embodiment of the invention, the cups are made by thermoforming a sheet of suitable plastic material. According to another embodiment of the invention, the cups and containers are made by injection molding. According to another embodiment of the invention, the cups are constructed from a polypropylene material. According to another embodiment of the invention, the cups are made from one of—polystyrene, high impact polystyrene, and styrene-butadiene copolymer. According to another embodiment of the present invention, the cup sidewalls are less than 0.013″ or 0.33 mm in thickness for cups having a capacity of less than about 6 oz. According to another embodiment of the present invention, the cup sidewalls are less than 0.012″ or 0.3 mm in thickness for cups having a capacity of less than about 5 oz. According to another embodiment of the present invention, the cup sidewalls are less than 0.011″ or 0.28 mm in thickness for cups having a capacity of less than about 4 oz. According to another embodiment of the present invention, the cup sidewalls are less than 0.010″ or 0.25 mm in thickness for cups having a capacity of less than about 3 oz. According to still another embodiment of the invention, the cup sidewalls have a thickness in the range of about 0.2 mm to about 0.25 mm for cups having a capacity of less than 3 oz.

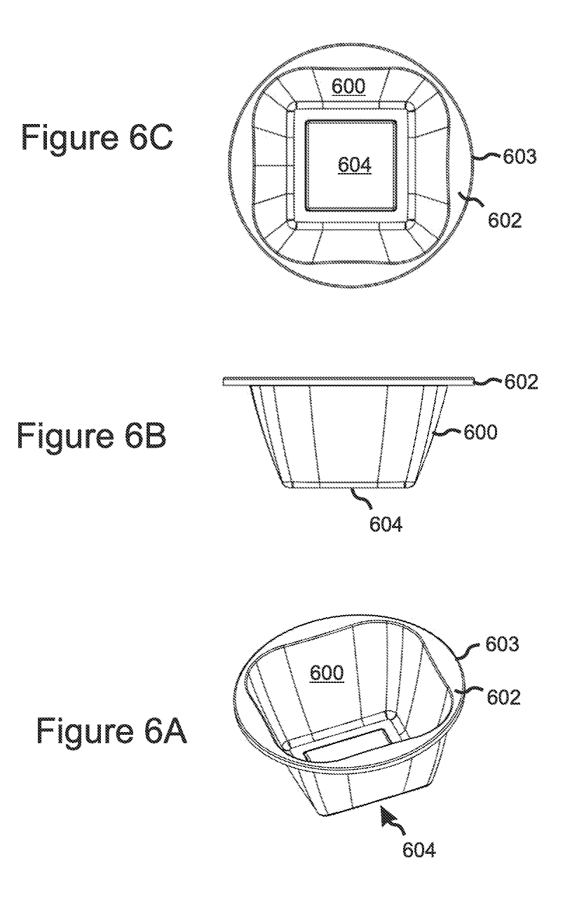

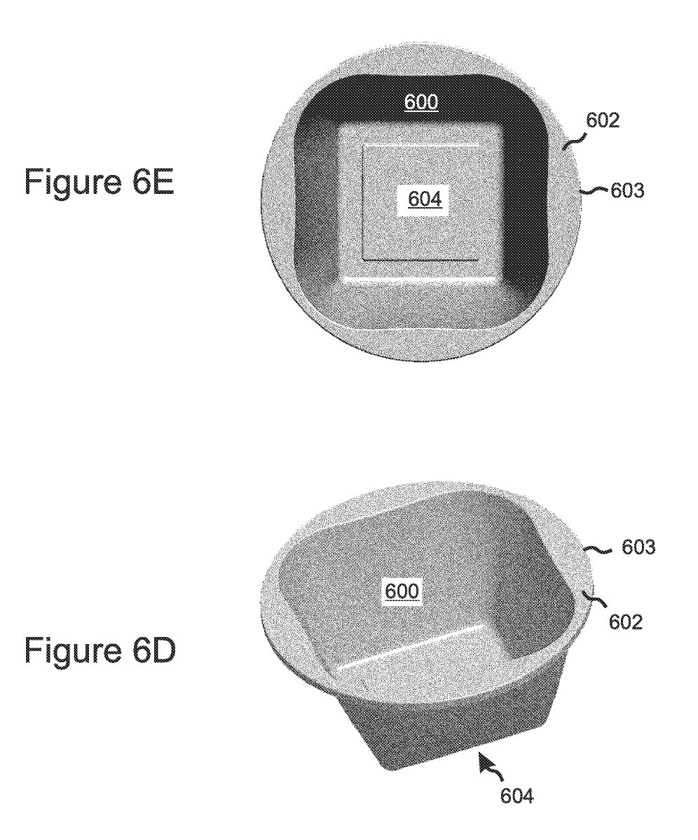

With reference to FIGS. 1A through 1C, according to a further embodiment of the present invention at least a portion of the cup sidewall is moderately concave and at least a portion of the outer edge of the cup upper rim is moderately convex. With reference to FIGS. 6A through 6E, according to yet another embodiment of the invention at least a portion of the cup sidewall is moderately concave and the outer edge of the cup upper rim is round. The concave shaping of the side walls in these embodiments ensures that any further inward deformation of the side walls must of necessity deform the upper rim, and the convex or round shaping of the outer edges of the upper rims in these embodiments provides enhanced resistance of the upper rims to deformation, thereby enhancing resistance of the side wall to deformation and providing enhanced side wall stiffness.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A container with enhanced resistance to sidewall compression, the container comprising:
a base defining a bottom closed end of said container and having four peripheral edges, said base being approximately square in shape;
four sidewalls, each sidewall comprising a top edge, a bottom edge and a pair of side edges,
said four sidewalls rising upwardly from said base with the bottom edges of the four sidewalls being respectively joined to said four peripheral edges of said base,
said four sidewalls being joined to each other at their side edges and defining an interior closed space for containing a substance therein,
the top edges of the four sidewalls being joined together to form a top inner periphery and defining a top open end of said container, said top inner periphery being approximately square in shape,
the four sidewalls being one of flat and bowed inward toward said interior closed space of the container; and
an upper rim circumscribing said top inner periphery and attached thereto at said top open end of said container, said upper rim having a top outer periphery, said upper rim being adapted to resist deformation thereof.

2. The container of claim 1, wherein the four sidewalls have heights which are not greater than their widths.

3. The container of claim 1, further comprising a lid which is configured for attachment to the upper rim.

4. The container of claim 1, wherein the container has an interior volume of approximately 2 fluid ounces.

5. The container of claim 1, wherein said container is adapted for tight nesting in a stack of a plurality of similar containers, said container being removable from said stack of said plurality of similar containers in a singulative manner.

6. The container of claim 1, wherein the four sidewalls are bowed inward toward said interior closed space of said container.

7. The container of claim 1, wherein at least portions of said top outer periphery of the upper rim are bowed outward away from said interior closed space of said container.

8. The container of claim 1, wherein said top outer periphery of the upper rim is round.

9. The container of claim 1, wherein said top outer periphery of said upper rim includes a downwardly projecting skirt.

10. The container of claim 1, wherein at least a portion of the container is made from a polypropylene material.

11. The container of claim 1, wherein at least a portion of the container is made from one of polystyrene, high impact polystyrene, and styrene-butadiene copolymer.

12. The container of claim 1, wherein the sidewalls are less than 0.33 mm in thickness, and the container has a fluid capacity of less than about 6 oz.

13. The container of claim 1, wherein the cup sidewalls are less than 0.3 mm in thickness, and the cup or container has a fluid capacity of less than about 5 oz.

14. The container of claim 1, wherein the sidewalls are less than 0.28 mm in thickness, and the container has a fluid capacity of less than about 4 oz.

15. The container of claim 1, wherein the sidewalls are less than 0.25 mm in thickness, and the container has a fluid capacity of less than about 3 oz.

16. The container of claim 1, wherein said container is injection molded.

17. The container of claim 1, wherein said container is a component of a cup and lid assembly for carrying food from one location to another, said food including one of dressings, condiments, sauces, butter, spread, and oil.

18. A method for manufacturing a cup or container with enhanced resistance to sidewall compression, said method comprising:
molding a plastic material to form a cup or container, the cup or container having:
a base defining a bottom closed end of said container and having four peripheral edges, said base being approximately square in shape;
four sidewalls, each sidewall comprising a top edge, a bottom edge and a pair of side edges:
said four sidewalls rising upwardly from said base with the bottom edges of the four sidewalls being respectively joined to said four peripheral edges of said base;
said four sidewalls being joined to each other by their side edges for defining an interior closed space for containing a substance therein and arranged to have a cross section which is approximately square in shape;
the top edges of the four sidewalls being joined together to form a top inner periphery and defining a top open end of said container, said top inner periphery being approximately square in shape;
the four sidewalls being one of flat and bowed inward toward said interior closed space of the container; and
an upper rim circumscribing said top inner periphery and attached thereto at said top open end of said container, said upper rim having a top outer periphery, said upper rim being adapted to resist deformation thereof.

19. The method of claim 18, wherein the cup or container is formed from a single, contiguous portion of plastic.

20. The method of claim 18, wherein the cup or container is formed from a single contiguous sheet of plastic.

21. The method of claim 18, wherein the cup or container is formed by thermoforming a contiguous sheet of plastic.

22. The method of claim 18, wherein the cup or container is formed by injection molding of the plastic.

23. The method of claim 18, wherein at least a portion of the cup or container is made from a polypropylene material.

24. The method of claim 18, wherein at least a portion of the cup or container is made from one of polystyrene, high impact polystyrene, and styrene-butadiene copolymer.

25. The method of claim 18, wherein the sidewalls are less than 0.25 mm in thickness.

26. The method of claim 18, wherein the container has a fluid capacity of greater than 1 oz.

27. The method of claim 18, wherein said cup or container is adapted for tight nesting in a stack of a plurality of similar cups or containers, said cup or container being removable from said stack of said plurality of similar cups or containers in a singulative manner.

28. The method of claim 18, wherein the four sidewalls are bowed inward toward said interior closed space of said cup or container.

29. The method of claim 18, wherein at least portions of said top outer periphery of the upper rim are bowed outward away from said interior closed space of said cup or container.

30. The method of claim 18, wherein said top outer periphery of the upper rim is round.

31. The method of claim 18, wherein said top outer periphery of said upper rim includes a downwardly projecting skirt.

32. The method of claim 18, wherein said cup or container is a component of a cup and lid assembly for carrying food from one location to another, said food including one of dressings, condiments, sauces, butter, spread, and oil.

33. A container having enhanced resistance to sidewall compression, the container comprising:
a base defining a bottom closed end of said container and having four peripheral edges, said base being approximately square in shape;
four sidewalls, each sidewall comprising a top edge, a bottom edge and a pair of side edges,
said four sidewalls rising upwardly from said base with the bottom edges of the four sidewalls being respectively joined to said four peripheral edges of said base,
said four sidewalls being joined to each other at their side edges and defining an interior closed space for containing a substance therein,
the top edges of the four sidewalls being joined together to form a top inner periphery and defining a top open end of said container, the inner periphery being approximately square in shape and said top edges of the four sidewalls being curved inwardly toward said interior closed space of the container; and
an upper rim circumscribing said top inner periphery and attached thereto at said top open end of said container, said upper rim having a top outer periphery, said upper rim being adapted to resist deformation thereof.

34. The container of claim 33, wherein at least a portion of the container is made from a polypropylene material.

35. The container of claim 33, wherein at least a portion of the container is made from one of polystyrene, high impact polystyrene, and styrene-butadiene copolymer.

36. The container of claim 33, wherein the sidewalls are less than 0.25 mm in thickness.

37. The container of claim 33, wherein the container has a fluid capacity of greater than 1 oz.

38. The container of claim 33, further comprising a lid which is configured for attachment to the upper rim.

39. The container of claim 33, wherein said container is adapted for tight nesting in a stack of a plurality of similar cups or containers, said container being removable from said stack of said plurality of similar cups or containers in a singulative manner.

40. The container of claim 33, wherein the four sidewalls are bowed inward toward said interior closed space of said container.

41. The container of claim 33, wherein at least portions of said top outer periphery of the upper rim are bowed outward away from said interior closed space of said container.

42. The container of claim 33, wherein said top outer periphery of the upper rim is round.

43. The container of claim 33, wherein said top outer periphery of said upper rim includes a downwardly projecting skirt.

44. The container of claim 33, wherein said container is a component of a cup and lid assembly for carrying food from one location to another, said food including one of dressings, condiments, sauces, butter, spread, and oil.

45. The container of claim 33, wherein said sidewalls have a thickness of between 0.2 mm to 0.25 mm.
